(19) United States
(12) Patent Application Publication
(10) Pub. No.: US 2025/0377303 A1
(43) Pub. Date: Dec. 11, 2025

(54) COMPUTER-IMPLEMENTED MULTISPECTRAL IMAGING METHOD AND SYSTEM

(71) Applicant: United Kingdom Research and Innovation, Swindon (GB)

(72) Inventors: James MANTON, Cambridge (GB); Akaash KUMAR, Alconbury (GB)

(73) Assignee: United Kingdom Research and Innovation, Swindon (GB)

(21) Appl. No.: 18/876,254

(22) PCT Filed: Jun. 29, 2023
(86) PCT No.: PCT/EP2023/067828

§ 371 Date: Dec. 18, 2024

(30) Foreign Application Priority Data
Jun. 30, 2022 (GB) 2209647.3

(51) Int. Cl. G01N 21/64

(52) U.S. Cl. CPC G01N 21/6458; G01N 21/6428; G01N 2021/6421; G01N 2021/6441; G01N 2021/6463; G01N 2201/126

(57) ABSTRACT

A computer-implemented multispectral imaging method for use in analysis of a sample comprising a plurality of types of fluorescent label, each of the plurality of types of fluorescent label having a respective emission spectrum is disclosed. The method comprises: receiving multi-channel image data, each channel in the multi-channel image data comprising image data derived from an unfiltered image of the sample and having a respective spectral content; for each channel: i) forming a vector of measured quantum particle counts from the image data for the channel, the vector having an entry for each pixel in the image; ii) iteratively generating, for each pixel in the image, a vector of possible values having entries for the contribution made by each of the plurality of types of fluorescent label to the unfiltered image, and for each iteration, calculating a vector of expected quantum particle counts, having an entry for each pixel in the image, by multiplying the vector of possible values for each pixel by a mixing matrix defining the relationship between the unfiltered image and the multi-channel image data; and iii) selecting the vectors of possible values for which a negative log-likelihood function describing the probability of a vector of measured quantum particle counts being generated given a corresponding vector of expected quantum particle counts is a minimum; and for each of the plurality of types of fluorescent label in the sample, constructing a corresponding data structure comprising image data in which, for each pixel, the data structure includes the entry for the contribution made by the type of fluorescent label from the vector of possible values for the pixel, each data structure thereby being useable to reconstruct an image of the sample with a spectral content corresponding to the respective emission spectrum of the type of fluorescent label for which the data structure was constructed.

### FIELD OF THE INVENTION

The invention relates to a computer-implemented multispectral imaging method for use in analysis of a sample comprising a plurality of types of fluorescent label. It also relates to a corresponding system and computer-readable medium.

### BACKGROUND

Fluorescence microscopy is a fundamental tool to study biological processes. Biological structures are labelled using either genetically-encoded fluorescent proteins or fluorescent dyes or probes. These types of fluorescent label are commonly referred to as “fluorophores”. These biological structures may be imaged using a fluorescence microscope. Each fluorophore has a characteristic excitation and emission spectra. The emission spectrum defines the wavelengths of light emitted by a fluorophore, whereas the excitation spectrum is the range of wavelengths that excite a fluorophore and cause it to emit light across its emission spectrum.

In fixed samples, biological targets are labelled with fluorophores to reveal the structural and spatial organisation within the sample which can subsequently be observed on a specific fluorescence microscope that suits the needs of the observer. Multiple different biological targets can be labelled with different fluorophores to reveal the spatial distribution and relationship between multiple biological structures.

Emission filters for each of the chosen fluorophores are used within the microscope to ensure that the signal being observed at any one time derives solely from the fluorophore matched to the currently-selected emission filter. The number of emission filters used within an experiment is equal to the number of fluorophores to observe. One fluorophore will be excited, and the emitted light will pass through the corresponding emission filter to a detector. Subsequently, the emission filter will be selected and a second fluorophore will be excited, the emitted light from the fluorophore passing through the newly-selected emission filter to the detector. This process continues for each of the fluorophores present in the sample. However, the use of this sequential process means that the speed of acquisition is a function of the number of fluorophores to observe. Moreover, the requirement to use mechanical filter switching to select each filter has a significant effect on the speed of acquisition.

Furthermore, with more than three fluorophores in a sample, it is not possible to use this sequential processing technique. This is because the excitation of one fluorophore may cause a non-specific excitation of another and because a portion of light emitted by one fluorophore may pass through the emission filter corresponding to another fluorophore, a situation referred to as “spectral bleedthrough”.

In order to image more than three fluorophores, a technique known as multispectral imaging must be employed which relies on discretising the emission spectra of fluorophores into multiple spectral wavebands. In this way, more information is collected about the emitted photons and mathematical processes can be applied a posteriori to reveal the underlying labelled structures within a specimen, a process referred to as “spectral unmixing”.

Commercial technologies for multispectral imaging in microscopy exist. Perhaps the most widely used is that of the Zeiss Quasar Detector. By employing a linear array of detection channels, multiple emission bands are imaged in parallel, thus enabling a selected spectral region to be obtained in a single scan across the specimen. In this implementation, a diffraction grating disperses the emitted fluorescence, which is then directed onto an array of precisely defined bandwidth channels in a specialized multi-anode photomultiplier (either 9.7-nanometer or 10.7-nanometer channels in a 32-channel detector) to generate a separate image for each channel. This technology is compatible only with conventional point scanning confocal microscopy which has limited applications for certain biological studies such as live imaging of specimens.

Another example of a commercial application of multispectral imaging is that of the Leica SP8 FALCON which utilises a prism to spectrally separate the emitted light onto a variety of detectors. The excitation of fluorophores used in the system can also be modulated via a white light excitation light source which can have tuneable excitation wavelengths using an acousto-optic tuneable filter. Furthermore, the fluorescent signals can be split in respect to time by measuring the time taken for emitted photons to reach the detectors or the “fluorescence lifetime” of the labels used in the experiment. However, again this method is compatible only with slow point scanning confocal microscopy which has limited applications to live cell imaging as above.

There exists a commercial gap for multispectral imaging of live samples that is compatible with optimised live imaging microscopy (such as light sheet microscopy). Multispectral imaging of live samples has been demonstrated in a research setting by Valm et al, 2017, Nature. 2017 Jun. 1; 546(7656): 162-167. They were able to spectrally resolve light emitted from six fluorophores within a live sample using Lattice Light Sheet Microscopy coupled to an excitation based multispectral imaging approach. A single image was taken at multiple excitation wavelengths and this data was subsequently spectrally unmixed a posteriori. This was a fundamental application of multispectral imaging. However, as the spectral data was acquired sequentially it was fairly slow which limits its applications for observing fast biological dynamics within the cell, for example.

Live imaging using fluorescence microscopy enables investigation of the spatiotemporal nature of various critical biological processes as the sample is kept alive whilst under observation on the microscope. A significant advance in live imaging is using light sheet microscopy as opposed to slow point scanning confocal microscopy. Using this technology an entire illuminated plane can be imaged at once making it much faster and gentler on the specimen. When trying to observe multiple fluorophores within a specimen, the process described above can be used, and the fluorophores may be imaged sequentially and independently with the same constraints regarding the number of fluorophores observable in time.

Multispectral imaging in live samples can be applied to light sheet microscopy but is more difficult for three reasons. First, the majority of multispectral imaging approaches are incredibly slow as they collect each spectral waveband sequentially increasing the acquisition time significantly. This directly affects sample viability, leading to phototoxicity and death.

Secondly, existing multispectral imaging approaches have been designed for point-scanning microscopes such as confocal microscopes meaning that the advantages of light sheet microscopy for live imaging cannot be realised.

Thirdly, spectral unmixing using conventional algorithms is highly dependent on Poisson noise, an inherent aspect of fluorescence imaging. This is less of an issue for fixed specimens where viability is not a consideration and the laser power and/or exposure time can be increased to improve the signal-to-noise ratio. However, in live imaging it is important to reduce the sample's exposure to light (in terms of intensity and time) meaning that the resulting images can have a higher noise component. There exists a trade-off between keeping the sample alive and collecting sufficient signal.

One example of a spectral unmixing technique is explored in “Blind Source Separation Techniques for the Decomposition of Multiply Labeled Fluorescence Images”, Biophysical Journal, Volume 96, May 2009, 3791-3800 by Neher et al. However, the techniques discussed in this document are computationally inefficient and do not allow the fast processing required with live imaging.

Another example is provided in “Spectral Imaging and Linear Unmixing in Light Microscopy”, Advances in Biochemical Engineering, Volume 95 by T. Zimmerman. However, this suffers from the abovementioned problem that it takes no account of the effects of Poisson noise in spectral unmixing.

### SUMMARY

In accordance with a first aspect of the invention, there is provided a computer-implemented multispectral imaging method for use in analysis of a sample comprising a plurality of types of fluorescent label, each of the plurality of types of fluorescent label having a respective emission spectrum, the method comprising:
receiving multi-channel image data, each channel in the multi-channel image data comprising image data derived from an unfiltered image of the sample and having a respective spectral content;
for each channel:
   i) forming a vector of measured quantum particle counts from the image data for the channel, the vector having an entry for each pixel in the image;
   ii) iteratively generating, for each pixel in the image, a vector of possible values having entries for the contribution made by each of the plurality of types of fluorescent label to the unfiltered image, and for each iteration, calculating a vector of expected quantum particle counts, having an entry for each pixel in the image, by multiplying the vector of possible values for each pixel by a mixing matrix defining the relationship between the unfiltered image and the multi-channel image data; and
   iii) selecting the vectors of possible values for which a negative log-likelihood function describing the probability of a vector of measured quantum particle counts being generated given a corresponding vector of expected quantum particle counts is a minimum; and
      for each of the plurality of types of fluorescent label in the sample, constructing a corresponding data structure comprising image data in which, for each pixel, the data structure includes the entry for the contribution made by the type of fluorescent label from the vector of possible values for the pixel, each data structure thereby being useable to reconstruct an image of the sample with a spectral content corresponding to the respective emission spectrum of the type of fluorescent label for which the data structure was constructed.

The invention solves the abovementioned problems. It collects the light emitted by many fluorescent labels simultaneously, leading to short acquisition times. The acquisition time is no longer a function of the number of fluorophores labelled within the sample, meaning that more information can be collected, revealing greater insights into biological processes without increasing the acquisition time.

It is also compatible with any form of microscopy, such as light sheet microscopy. Moreover, by selecting the vectors of possible values for which the negative log-likelihood function describing the probability of a vector of measured quantum particle counts being generated given a corresponding vector of expected quantum particle counts is a minimum, the invention can handle spectral unmixing in samples where there is a large contribution of Poisson noise (i.e. a low signal-to-noise ratio).

It should also be noted that, although the system can process light collected from many fluorescent labels simultaneously, it is beneficial even when used with only one fluorescent label. Since emission filters are not used, a larger proportion of the emission spectra of the fluorescent labels is collected which improves the signal-to-noise ratio. This has profound implications for live imaging as the laser power and exposure time can be reduced, improving sample viability.

In a preferred embodiment, the quantum particles in the measured quantum particle counts and expected quantum particle counts are photons.

In other embodiments, the quantum particles may be electrons. This would be the case when, for example, the invention is used in the context of electron microscopy. In this case, the references to spectral content should be understood to be refer to a range of electron energies.

The number of channels in the multi-channel image data may be greater than 3. A typical number of channels in the multi-channel image data is 8, although higher numbers, such as 16, 32 or 64 are possible. The number of channels may be equal to the number of types of fluorescent label in the plurality of fluorescent labels. However, in other circumstances, the number of channels may be less than or more than the number of types of fluorescent label in the plurality of fluorescent labels.

The method may further comprise reconstructing an image of the sample using one or more of the data structures comprising image data.

The iterative generation of step (ii) and selection of step (iii) may be carried out using an optimisation algorithm, such as limited-memory Broyden-Fletcher-Goldfarb-Shanno, conjugate gradient descent, Adam or Richardson-Lucy.

In a preferred embodiment, the optimisation algorithm is Richardson-Lucy which performs the iterative generation of step (ii) according to the following equation:

$${u}_{k + 1} = {u}_{k} [ {H}^{T} ( \frac{d}{H {u}_{k}} ) ]$$

where: uₖ is a current iteration of the vector of possible values;
   uₖ₊₁ is the next iteration of the vector of possible values;
   H is the mixing matrix, and H^{T} its transpose; and
   d is the vector of measured quantum particle counts;
      and wherein the vector of possible values selected in step (iii) is the final value of uₖ₊₁ generated prior to interruption of the iterative generation, the interruption being triggered when over a predefined number of successive iterations, the values of uₖ₊₁ differ by less than a threshold amount.

The predefined number of successive iterations may be any number from 2 upwards, with typical numbers being 10, 20, 50 or 100. The threshold amount may be a fixed amount or it may be a proportion of the value of uₖ₊₁.

The mixing matrix may define, in addition to the relationship between the unfiltered image and the multi-channel image data, a function for deblurring caused by diffraction or other optical effects. Essentially, the mixing matrix required to undo the effects of spectral mixing can be modified to create a composite matrix which will undo both the spectral mixing and blurring or any other undesired linear image formation process.

The method may further comprise generating the mixing matrix.

The method may further comprise generating the multi-channel image data by splitting light received from an image source which produces the unfiltered image into a number of optical paths, the number of optical paths equal to the number of channels in the multi-channel image data and each optical path having the same spectral content as a corresponding one of the channels; forming an image from the light in each optical path; and generating image data for the channel corresponding to the optical path from the image formed.

The light received from the image source is typically split into the optical paths using an array of dichroic mirrors, and the image in each optical path is formed on a respective camera which generates the image data.

In another aspect of the invention, there is provided a multispectral imaging system for use in analysis of a sample comprising a plurality of types of fluorescent label, each of the plurality of types of fluorescent label having a respective emission spectrum, the system comprising at least one processor coupled to at least one memory device, the memory device storing instructions which, when executed, cause the processor to carry out the method of the first aspect of the invention.

The system may further comprise an array of dichroic mirrors to split light received from an image source which produces the unfiltered image into a number of optical paths, the number of optical paths equal to the number of channels in the multi-channel image data and each optical path having the same spectral content as a corresponding one of the channels; and a camera in each optical path on which an image is formed to generate the image data for the channel corresponding to the optical path.

In yet another aspect of the invention, there is provided a computer readable medium storing instructions to be executed by a processor forming part of a multispectral imaging system for use in analysis of a sample comprising a plurality of types of fluorescent label, each of the plurality of types of fluorescent label having a respective emission spectrum, wherein the instruction, when executed on the processor, cause the processor to carry out the method of the first aspect of the invention.

### BRIEF DESCRIPTION OF THE FIGURES

Embodiments of the invention will now be described with reference to the accompanying figures in which:

FIG. 1 shows a block diagram of a system according to the invention.

FIG. 2 shows the emission spectra of a set of different fluorophores.

FIG. 3 shows a schematic diagram of an optical splitter for use with the invention.

FIG. 4 shows a flowchart of one embodiment of a method according to the invention.

FIG. 5 shows a flowchart of another embodiment of a method according to the invention using the Richardson-Lucy algorithm.

FIGS. 6a to 6c show the results of applying a method according to the invention to simulated multispectral data and to different biological targets.

FIG. 7 shows a photograph of an optical splitter according to the schematic diagram of FIG. 3 used in an example application of the invention.

FIGS. 8a and 8b show the camera tree of FIG. 7 attached to a spinning disc confocal and an oblique plane light sheet microscope respectively.

FIGS. 9a to 9f show the results of applying a method according to the invention to biological targets imaged by the microscopes of FIGS. 8a and 8b.

### DETAILED DESCRIPTION

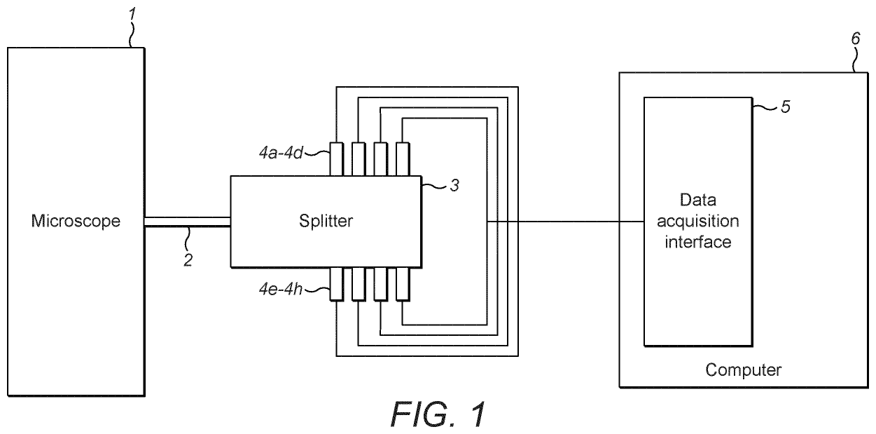

FIG. 1 shows a block diagram of a suitable system for use in analysis of a sample comprising a plurality of types of fluorescent label. In this system, a microscope 1 is optically coupled by way of an optical link 2 to an optical splitter 3. The microscope 1 can be any microscope with a suitable optical output. For example, a microscope having an optical output for coupling to a camera to capture images from the microscope would generally be suitable. The nature of the optical link 2 depends on the nature of the microscope's optical output, but in many cases a simple collection lens can be used to collimate the light output from the microscope 1 for further optical processing by the optical splitter 3.

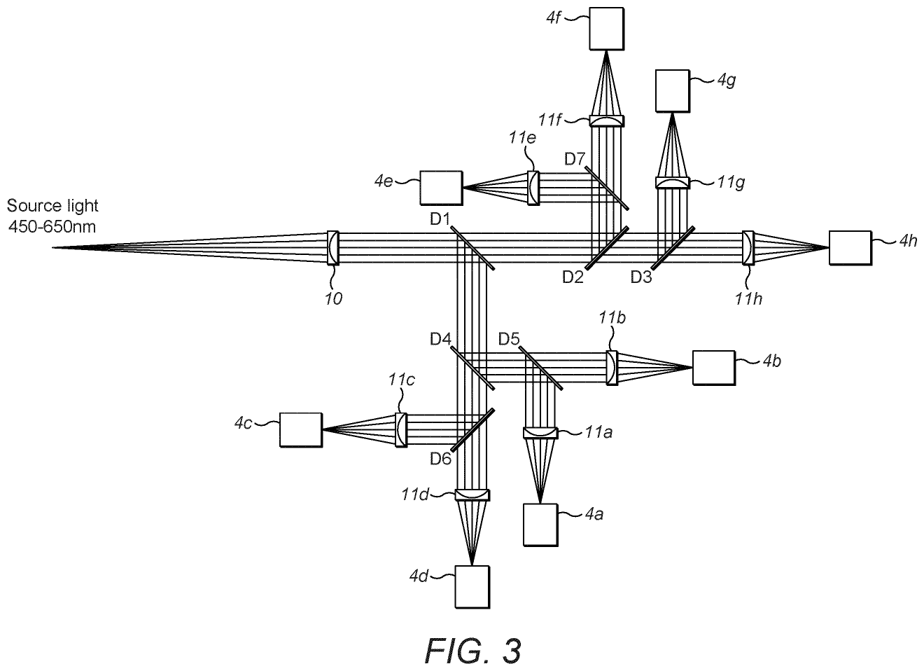

The structural arrangement of the optical splitter 3 will be explained later with reference to FIG. 3. For now, the functional nature of the optical splitter 3 will be discussed. The optical splitter 3 splits the light received from the optical link 2 into eight separate channels, each with a respective bandwidth. For example, where the entire emission spectrum received from the microscope via optical link 2 is in a range of 450 nm to 650 nm then each channel may cover a respective 25 nm portion of this 200 nm range.

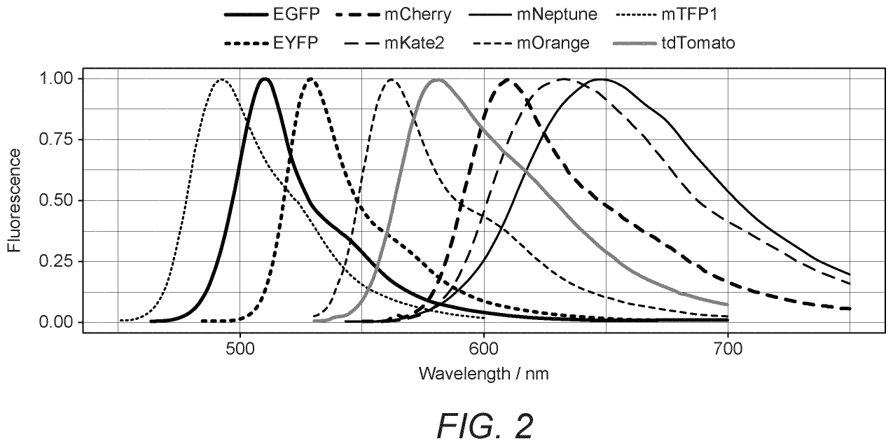

FIG. 2 shows the spectral emission of each of a set of eight different fluorophores, known as EGYP, mCherry, mNeptune, mTFP1, EYFP, mKate2, mOrange, and tdTomato. As can be seen, despite the fact that the emission spectrum of each fluorophore is relatively narrow, they do overlap considerably. The function of the optical splitter 3 is therefore not enough to isolate the light emitted from each fluorophore into a respective one of the channels. Instead, each fluorophore will provide a contribution to each of the channels. This contribution can be easily measured or predicted given the knowledge of the bandwidth of the channel and the light output of each fluorophore within this bandwidth.

Each channel focuses its respective spectral portion of light onto a camera, depicted as 4a to 4h in FIG. 1. The cameras 4a to 4h are coupled to a data acquisition interface 5. The data acquisition interface 5 is provided within (for example, in the form of a PCI card) a computer 6 which executes software for processing the acquired data as will be described below. In other embodiments, the data acquisition interface 5 may be external to the computer 6. The computer 6 can be any general purpose personal computer. The data acquisition interface 5 comprises a set of analogue-to-digital converters which receive the image data from the cameras 4a to 4h and convert it into a digital representation of the image acquired by each camera 4a to 4h. The digital representation gives a reading for each pixel that is proportional to the number of photons that have fallen on that pixel. The photon counts can then be combined into a vector, each channel from the splitter 3 having a respective vector of the photon counts at each pixel. Thus, a vector of measured photon counts for each pixel in each channel can be formed from the images captured by cameras 4a to 4h.

The structure of splitter 3 is shown in FIG. 3. The collection lens 10 mentioned previously receives light from the output of the microscope 1 with a full spectral bandwidth of 450 nm to 650 nm and collimates it. A set of seven longpass dichroic mirrors D1 to D7 is responsible for splitting the light by wavelength into the eight channels. Each of the mirrors D1 to D7 has a different cut-on wavelength and splits the light it receives in a manner dependent on its wavelength into the eight separate channels, each occupying a respective 25 nm portion of the full spectral bandwidth. The light in each channel will pass through three of the mirrors D1 to D7 before being focused by a respective tube lens 11a to 11h onto the respective one of the cameras 4a to 4h. This enables the simultaneous acquisition of the eight different channels, which is eight times faster than using a sequential acquisition technique.

There is a trade-off between the number of channels and the channel bandwidth. If there are too many channels then the channel bandwidth decreases and the signal-to-noise ratio rises since fewer photons are collected in each channel. If there are too few channels, the spectral separation is not enough to enable the spectral unmixing to be carried out effectively. The use of eight channels represents a good practical compromise in this trade-off.

The placement of the dichroic mirrors D1 to D7 affects the spatial resolution of the splitter 3, as does the distance between the object plane and the image plane created by each lens 11a to 11h. However, it is straightforward to optimise the placement of these components to obtain a suitable image quality by modelling the point spread function using a suitable software tool such as Zemax OpticStudio. The lenses 11a to 11h visualise the entire visible spectrum so there is no need to consider chromatic aberration.

As explained earlier, the multi-channel image data provided by the optical splitter 3 in conjunction with the data acquisition interface 5 is used to form, for each channel, a vector of measured photon counts, each of the vectors having an entry for each pixel in the image represented by the image data.

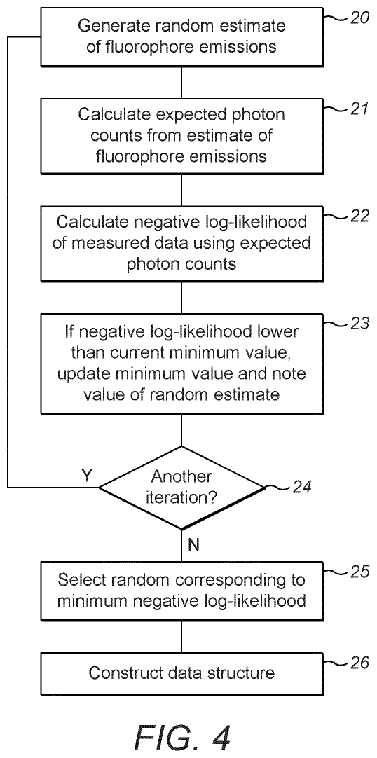

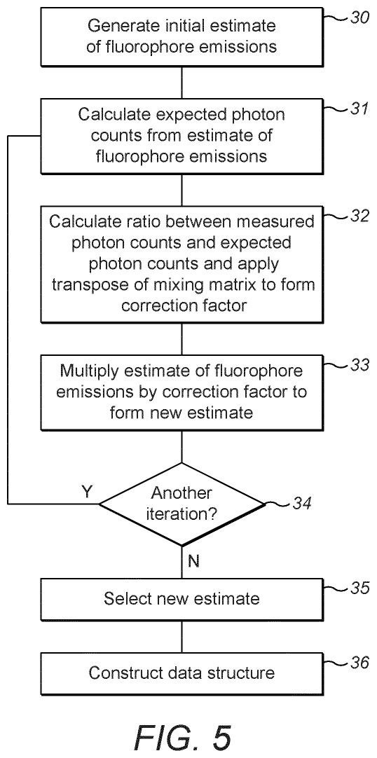

The processing of the data then continues as shown in FIGS. 4 and 5. These will be explained below. However, first, it is helpful to discuss some of the theoretical background to the processing techniques shown in FIGS. 4 and 5.

The expected light intensity yᵢⱼ in a particular channel i, at a particular pixel j, is the sum of contributions from different fluorescent labels k. These labels contribute to the light intensity in proportion to their concentration xₖⱼ at the pixel j, and to the proportion of emission aᵢₖ that falls into the spectral range of channel i:

$${y}_{i j} = {\sum }_{k = 1}^{F} {a}_{i j} {x}_{k j}$$

where the sum runs over all the different fluorescent labels, k=1, . . . , F. As a matrix equation, this can be written as:

$$Y = M X$$

where M is a mixing matrix defining behaviour of the optical splitter 3 and data acquisition interface 5, in other words defining the relationship between the unfiltered image and the multi-channel image data.

However, the expected value of light intensity is rarely measured in practice since the actual number of detected photons is distributed according to a Poisson distribution (owing to the shot noise inherent with quantised radiation) parameterised by this expectation value. As such, the probability of measuring N photons is given by:

$$P ( N , M X ) = \frac{{( M X )}^{N} {e}^{- M X}}{N !}$$

As mentioned before, conventional spectral unmixing algorithms ignore this shot noise behaviour and instead assume that the detected signal is equal to the expected value (i.e. they work in the high signal-to-noise ratio limit where the contribution from shot noise can be neglected). In this approach, the underlying fluorophore concentrations is estimated by:

$$\hat{X} = {M}^{- 1} Y$$

where M⁻¹ denotes the matrix inverse (or, in the case of non-square matrices, the Moore-Penrose pseudo-inverse) of M. This can often lead to negative values for \hat{X}, which are clearly nonsensical as the concentrations provided by a fluorophore cannot be negative.

In this invention, the spectral unmixing scenario is instead formulated as an optimisation of a negative log-likelihood function constructed using knowledge that the data will be affected by Poisson noise. In particular, for K pixels and given a vector of expected photon counts per pixel, E, and a vector of measured photon counts per pixel m, the likelihood of the expected photon counts generating the measured photon counts is given by:

$$P ( m \vert E ) = {\prod }_{i}^{K} \frac{{E}_{i}^{{m}_{i}} {e}^{- {E}_{i}}}{{m}_{i} !}$$

Taking the logarithm and negating this gives the negative log-likelihood function:

$$log ( P ( m \vert E ) ) = {\sum }_{i}^{K} [ log ( {m}_{i} ! ) + {E}_{i} - {m}_{i} log {E}_{i} ]$$

Given this, if we have a way of calculating a vector of expected photon counts given some underlying guess for the contribution made by each of the plurality of types of fluorescent label to the light emitted from a sample, we can find the guess most likely to have produced the measured photon counts by minimising this function. This minimising process can be carried out simply by creating random values for the contribution made by each of the plurality of types of fluorescent label and iterating the calculation. This is shown in FIG. 4.

The process starts at step 20 by generation of a random estimate of the emission contributed, on a pixelwise basis, by each of the plurality of types of fluorescent label to the light emitted from a sample under analysis. This is done by forming a vector, for each pixel, having an entry for the random estimation of the contribution provided by each of the plurality of types of fluorescent label.

In step 21, the expected photon counts for each pixel that would be generated given the random estimate generated in step 20 can be calculated. This can be done by matrix multiplication of the random estimate generated in step 20 by the mixing matrix M. The mixing matrix can be straightforwardly determined given the knowledge of the arrangement of the optical splitter 3 and operation of the data acquisition interface 5.

The negative log-likelihood function is calculated in step 22 using the above equation with the expected photon counts calculated in step 21 and the measured photon counts received from the data acquisition interface 5 as parameters.

In step 23, an assessment is made as to whether the negative log-likelihood calculated in step 22 is lower than a current minimum value (which can be seeded with an arbitrarily high value in advance of the first iteration of the process shown in FIG. 4). If it is, then the current minimum value is replaced with the one just calculated. This is done because the negative log-likelihood calculated in step 22 is now the minimum and so the random estimate of fluorophore emissions generated in step 20 of the current iteration around the loop shown in FIG. 4 is now the most likely to have resulted in the measured photon counts from the data acquisition interface 5.

The process of steps 20 to 23 is carried out iteratively until a decision is made in step 24 to interrupt the process. This decision can be based on a number of things. For example, the iterative process of steps 20 to 23 could be run until a predetermined number of iterations has been run, in which case step 24 will count the iterations and interrupt the process when the predetermined number has been reached. Alternatively, step 24 could interrupt the process when there has been no new minimum value for the negative log-likelihood calculated in step 23 for a given number of iterations of the process of steps 20 to 23.

In step 25, the values of the random estimates recorded in step 23 which correspond to the minimum negative log-likelihood are selected. Steps 20 to 25 are repeated for each channel of the optical splitter 3.

The values selected in step 26 are used to construct a data structure for each of the plurality of types of fluorophore in the sample. Each of these data structures comprises image data which, for each pixel, includes the entry for the contribution made by the type of fluorescent label from the vector of random estimated values for the pixel calculated in step 20. Each data structure can then be used to reconstruct an image of the sample with a spectral content corresponding to the respective emission spectrum of the type of fluorescent label for which the data structure was constructed.

Whilst the process of FIG. 4 works, it is not particularly computationally efficient. A more efficient process is shown in FIG. 5. In this process, the negative log-likelihood function is minimised by use of an optimising algorithm. A number of different algorithms could be used. These include limited-memory Broyden-Fletcher-Goldfarb-Shanno, conjugate gradient descent and Adam. However, the process of FIG. 5 uses Richardson-Lucy for its ease of implementation, computational efficiency, and extendability.

In general, the Richardson-Lucy algorithm forms a new estimate, uₖ₊₁, from the current estimate, uₖ, by:

$${u}_{k + 1} = {u}_{k} \cdot [ {H}^{T} ( \frac{d}{H {u}_{k}} ) ]$$

where the · denotes pointwise multiplication, H^{T} is the transpose (or dual) of the measurement operator H, and d is the measured data.

In the case of the spectral unmixing scenario, H is the mixing matrix M, and d represents the measured photon counts acquired by the optical splitter 3 and data acquisition interface 5. uₖ and uₖ₊₁ represent current and new estimates respectively for the emission contributed by each of the plurality of types of fluorescent label to the light emitted from a sample under analysis.

The process starts in step 30 where an initial estimate for the emission contributed by each of the plurality of types of fluorescent label to the light emitted from a sample under analysis is generated. This is done by forming a vector, for each pixel, having an entry for the estimation of the contribution provided by each of the plurality of types of fluorescent label. At this stage, the estimation can be nothing more than randomly generated values.

In step 31, expected photon counts can be calculated from the estimated values for the contributions provided by each of the plurality of types of fluorescent label. In the first iteration around the loop of steps 31 to 33, the estimated value will be those calculated in step 30. In subsequent iterations, it will be a new estimate that will be calculated in step 33 of the preceding iteration. The expected photon counts are the term Huₖ in the above equation.

In step 32, the ratio of the measured photon counts provided by the data acquisition interface 5 based on the measurements provided from the cameras 4a to 4h on the optical splitter 3 and the expected photon counts calculated in step 31 is calculated. This ratio is then multiplied by the transpose of the mixing matrix to form a correction factor. The estimate of the contribution provided by each of the plurality of types of fluorescent label is then multiplied by the correction factor in step 33. This results in a new estimated value.

The loop of steps 31 to 33 is repeated iteratively until a decision is made in step 34 to interrupt the process. This decision is reached when the estimated value uₖ₊₁ calculated in step 33 does not change by more than a threshold amount over a predefined number of successive iterations of steps 31 to 33. For example, the predefined number of successive iterations may be 10, 20, 50 or 100, and the threshold amount could be any suitable fixed number or a proportion of the estimated value uₖ₊₁.

In step 35, the estimated value uₖ₊₁ calculated in the final iteration is selected. The process of steps 30 to 35 are then repeated for each channel of the optical splitter 3.

The values selected in step 35 are used to construct a data structure for each of the plurality of types of fluorophore in the sample. Each of these data structures comprises image data which, for each pixel, includes the entry for the contribution made by the type of fluorescent label from the vector of estimated values for the pixel calculated in step 33 of the final iteration. Each data structure can then be used to reconstruct an image of the sample with a spectral content corresponding to the respective emission spectrum of the type of fluorescent label for which the data structure was constructed.

An example of the operation of the system can be shown by the following illustration. This represents only a simplified version of a real system in order that it can be easily understood. In the simplified illustration, a mixing matrix is as follows:

$$M = [ \begin{matrix}1 & 0 & 2 \\ 1 & 2 & 0 \\ 0 & 1 & 1\end{matrix} ] ,$$

the contribution provided each of three fluorophores for a single pixel are:

$$X = [ \begin{matrix}20 \\ 17 \\ 2\end{matrix} ] ,$$

and the measured photon counts in each of three channels are:

$$Y = [ \begin{matrix}19 \\ 58 \\ 13\end{matrix} ]$$

The conventional approach of the prior art using matrix inversion discussed earlier gives:

$$\hat{X} = [ \begin{matrix}0.50 & 0.50 & - 1.00 \\ - 0.25 & 0.25 & 0.50 \\ 0.25 & - 0.25 & 0.50\end{matrix} ] [ \begin{matrix}19 \\ 58 \\ 13\end{matrix} ] = [ \begin{matrix}25.5 \\ 16.25 \\ - 3.25\end{matrix} ]$$

This has the issue that one of the estimated values is negative.

After 138 iterations of the Richardson-Lucy algorithm as illustrated in FIG. 5 and discussed above, the following estimate for the underlying fluorophore contributions is provided:

$$\hat{X} = [ \begin{matrix}20.9752 \\ 16.0165 \\ 0.0000\end{matrix} ]$$

This does not suffer from the issue of negative estimated values for the fluorophore contributions. In addition, the estimate for the first value is much closer to the real value, and that for the second and third are acceptably close. After these 138 iterations, the change in estimates from one iteration to the next is small enough that the algorithm can be considered to have converged on a final solution.

Another advantage of using an optimisation algorithm such as Richardson-Lucy to minimise the negative log-likelihood function is that it is relatively straightforward to include other effects into the overall measurement operator, H. For example, we can include the effect of diffractive blurring by creating a composite H operator that describes how the light from each fluorophore is blurred and then mixed. The composite operator is obtained by the composition of the mixing operator M and another operator (the so-called ‘point spread function’) defining the blurring process. This way the invention will reverse both the spectral mixing and the diffractive blurring.

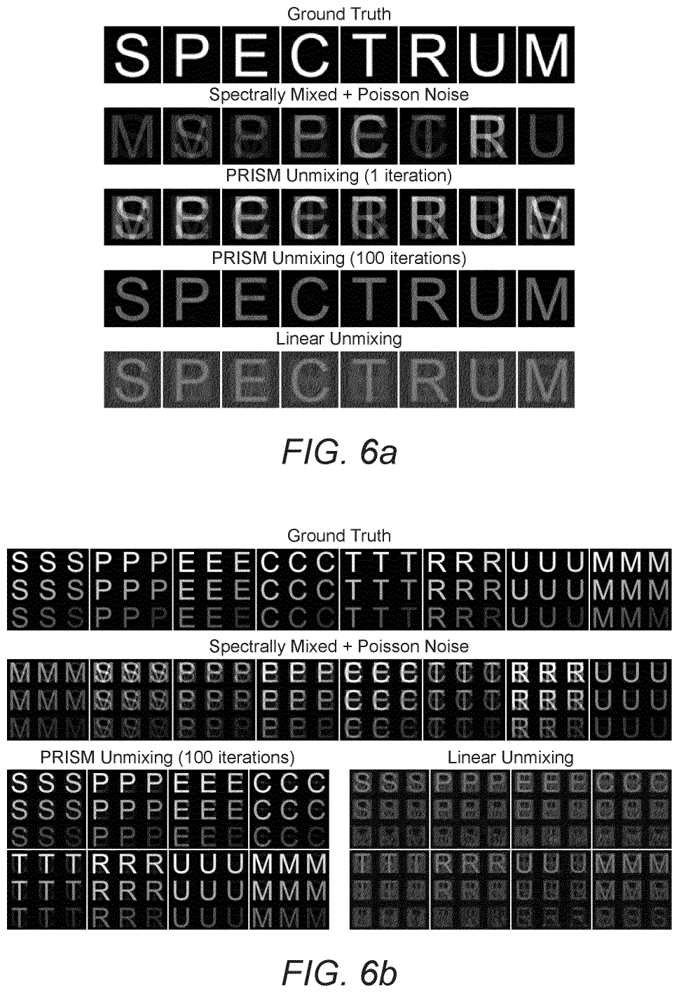

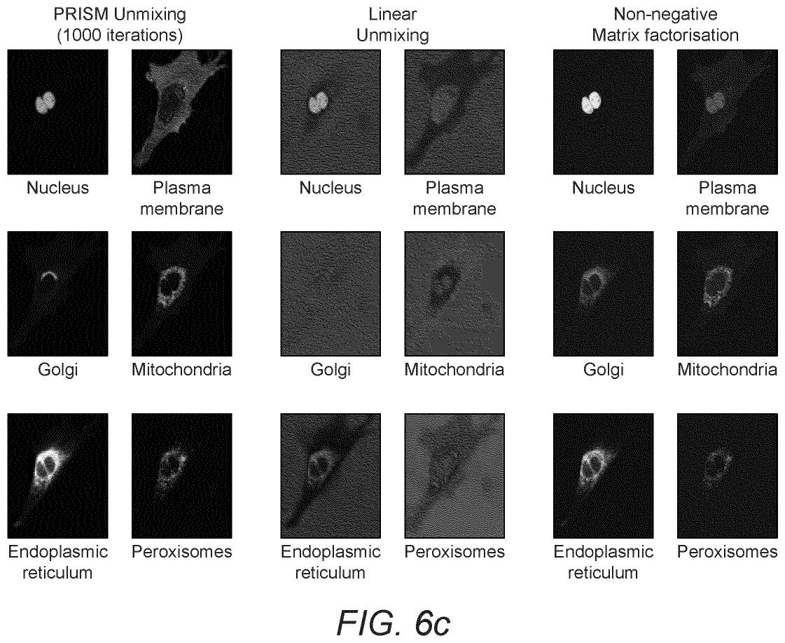

The application of the invention is illustrated below by way of some examples. Spectral unmixing software, named PRISM Unmixing, was developed to carry out the invention. This software was first tested on simulated multispectral data and compared against conventional linear unmixing algorithms. The results are shown in FIGS. 6a and 6b. In FIG. 6a, eight ground truth targets were simulated to represent eight different biological targets tagged with eight fluorophores (each simulated target being one of the letters of the word ‘SPECTRUM’ shown in FIG. 6a). These targets are shown in the top row of FIG. 6a. They were spectrally mixed, and Poisson noise was added to simulate low signal-to-noise ratio (SNR) fluorescence microscopy data. The results of this are seen in the second row of FIG. 6a.

We then carried out the invention using the PRISM Unmixing software as well as the ‘gold standard’ Linear Unmixing. The results of 1 iteration and of 100 iterations of the PRISM Unmixing software are seen in the third and fourth rows of FIG. 6a. The results of Linear Unmixing are seen in the fifth row of FIG. 6a. If it clear that the PRISM Unmixing software has superior performance. In the original image data, red pixels denote erroneous negative pixel values in the dataset. These are only reproducible here in greyscale, but the result is the background artefacts behind the desired output seen in the Linear Unmixing row shown in FIG. 6a. The same artefacts are clearly not visible with PRISM Unmixing, especially after 100 iterations. PRISM Unmixing successfully reconstructs the Ground Truth data, whereas the Linear Unmixing does not.

Furthermore, the errors get worse when unmixing dimmer samples. This is shown in FIG. 6b where the Ground Truth dataset is now an array of different brightnesses. This is shown in the top row of FIG. 6b with the spectrally mixed data with Poisson noise added in the next row.

The results of PRISM Unmixing and Linear Unmixing are shown in the third row of FIG. 6b. PRISM Unmixing reconstructs the Ground Truth data successfully even for the dimmest samples, whereas Linear Unmixing makes errors throughout, the errors being worse with dimmer input data. Again, this demonstrates the superiority of PRISM Unmixing with respect to the ‘gold standard’ Linear Unmixing technique.

The PRISM Unmixing software was subsequently tested on real microscopy data from conventional multispectral imaging modalities (32 channel Zeiss QUASAR) using fixed U2OS cells labelled with 6 different fluorescent proteins tagged to 6 biological structures: cell nucleus; golgi; endoplasmic reticulum; plasma membrane; mitochondria; and peroxisomes. FIG. 6c shows the results of PRISM Unmixing (left-hand column), Linear Unmixing (centre column) and Non-Negative Matrix Factorization (NMF) (right-hand column), a more advanced spectral unmixing technique than Linear Unmixing. After 1000 iterations of PRISM Unmixing, the underlying six biological targets in the cell were successfully unmixed and identified. Again, the Linear Unmixing results suffered from severe errors with many negative pixel values. These negative pixel values were highlighted in red in the original image data, but this can only be reproduced in greyscale here. It results in the severe background “haze” which obscures the desired image data. The results from the NMF were also poor compared to PRISM Unmixing, as the unmixed data had many erroneous results, where biological targets were mis-assigned to the wrong channels resulting in erroneous identification of the six biological targets. For example, the nucleus signal can be seen in the plasma membrane image, and the endoplasmic reticulum can be seen in the golgi image. None of these errors occurs in the PRISM Unmixing results. This data demonstrates PRISM Unmixing enhanced capability in spectrally unmixing low signal-to-noise ratio microscopy data compared to other existing techniques.

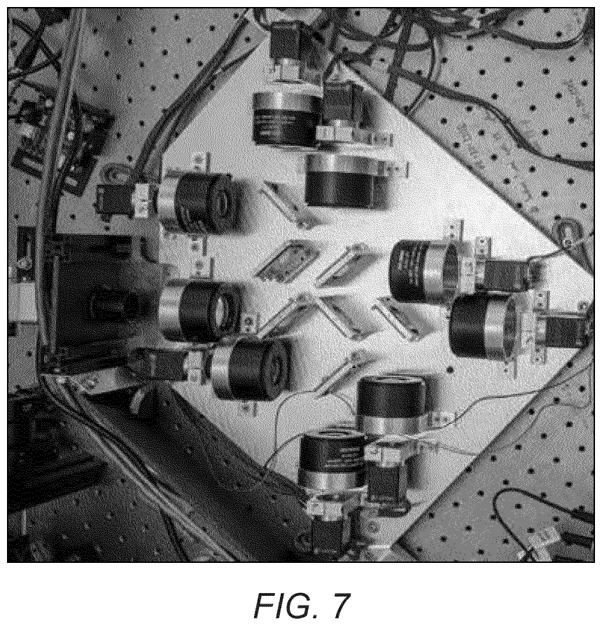

To exploit the advantages of our PRISM software, we constructed a novel eight-way camera module to image, for the first time, eight spectral channels simultaneously. This was constructed according to the schematic shown in FIG. 3. The finished module can be seen in FIG. 7. This module has been designed to work with any camera-based fluorescence microscope.

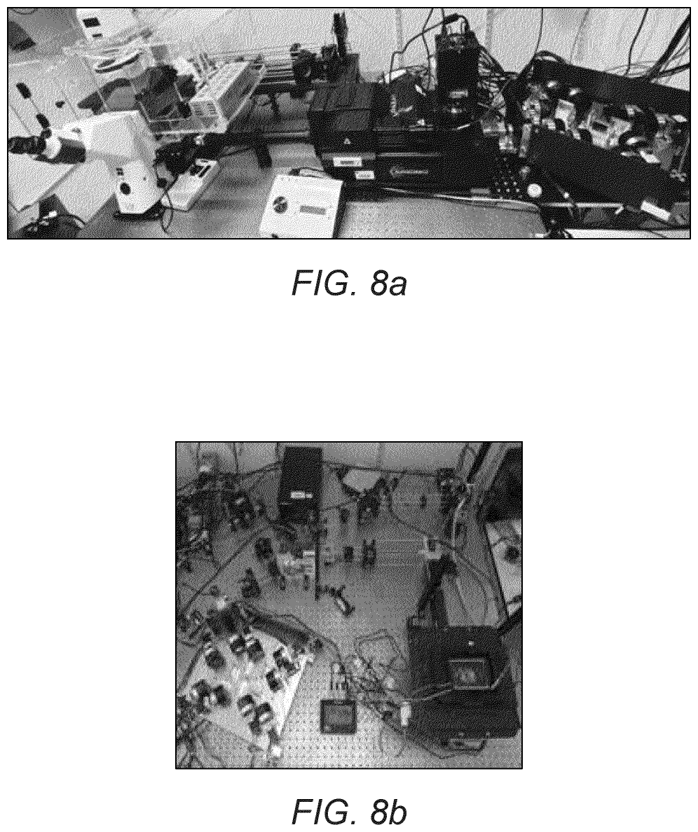

To demonstrate the capabilities of our technology, we attached the camera module to a spinning disc confocal microscope, as shown in FIG. 8a, and to an oblique plane light sheet microscope, as shown in FIG. 8b. In FIG. 8a, the microscope stand is visible to the left-hand side of the photograph, the spinning disc confocal microscope is in the middle, and the camera module is to the right-hand side. In FIG. 8b, the camera module is visible ion the lower left-hand corner of the photograph.

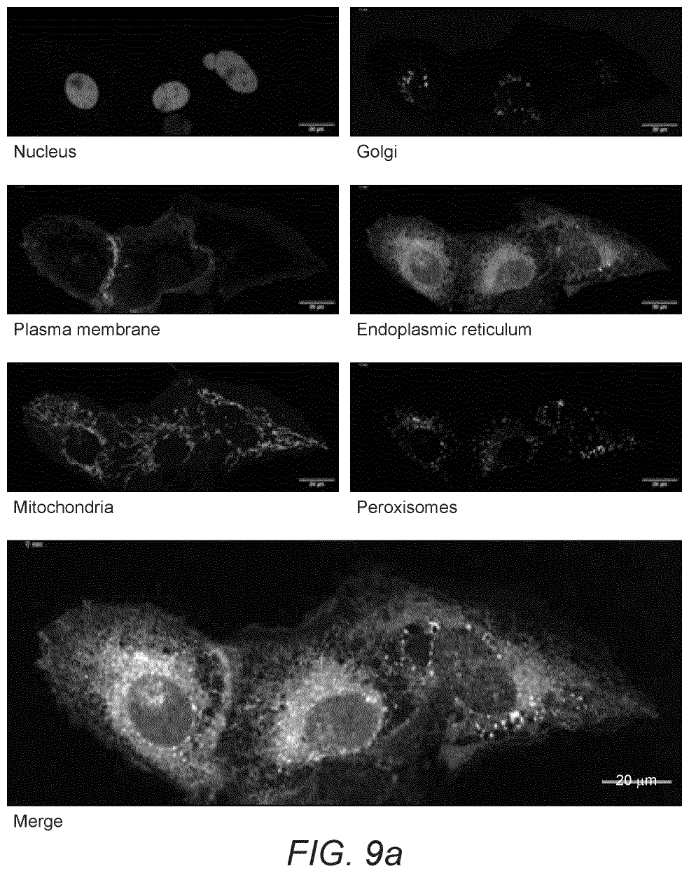

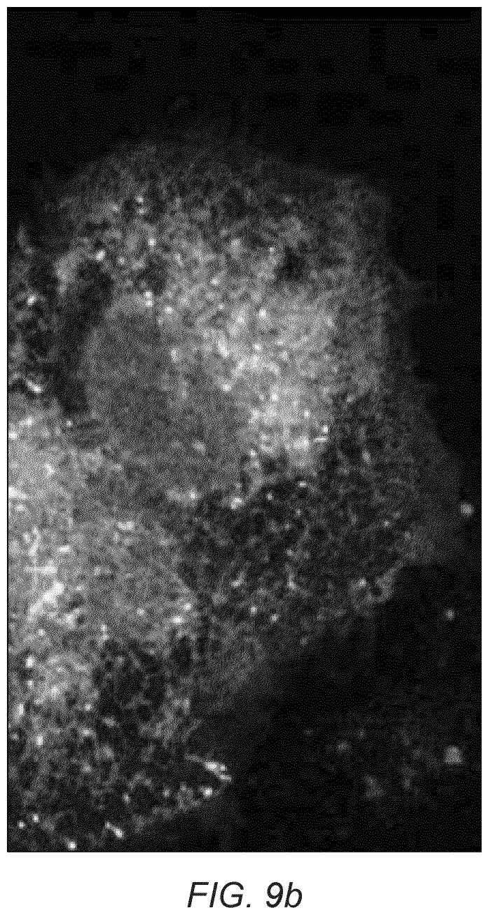

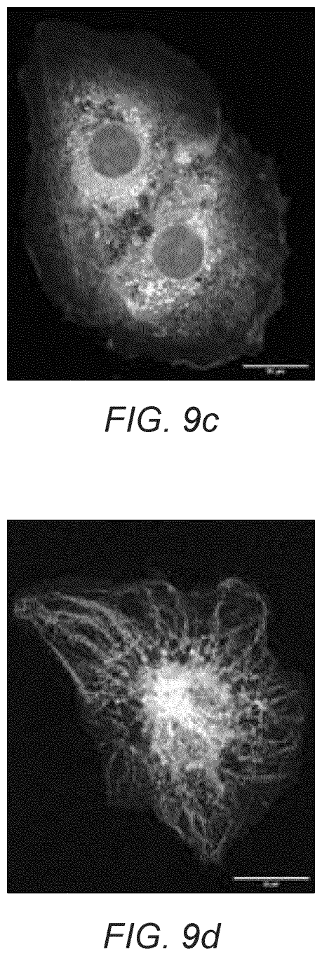

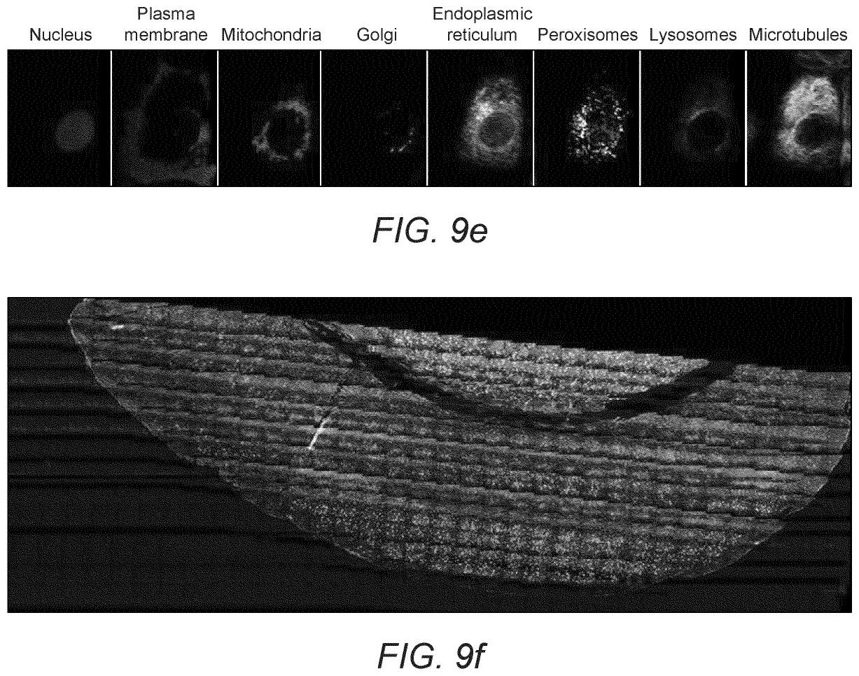

Using the arrangements of FIGS. 8a and 8b, the inventors have successfully demonstrated imaging of one to eight fluorescent probes, simultaneously, in multiple samples, both live and fixed, for the first time followed by spectrally unmixed the data using the PRISM Unmixing software. Some of the results for datasets labelled with five to eight fluorescent probes are shown in FIGS. 9a to 9f. The fluorescent probes tested on samples included both fluorescent proteins and dyes. The fluorescent proteins tested were: TagBFP; Cerulean; mAzami Green; Citrine; mCherry; iRFP670; mScarlett; and mOrange2. The fluorescent dyes tested were: DAPI; SPY 555 Tubulin; FASTACT 555 Actin; LysoTracker Yellow HCK-123; OPAL 520; OPAL 570; OPAL 650; and OPAL 690.

FIG. 9a shows a six-colour image of live U2OS cells captured with the spinning disc confocal microscope of FIG. 8a. The cells were labelled with TagBFP, Cerulean, mAzami Green, Citrine, mCherry and iRFP670 to highlight the following biological structures: the cell nucleus; the plasma membrane; the mitochondria; golgi; the endoplasmic reticulum; and peroxisomes. The separated, unmixed data can be seen showing the individual biological structures as well as a merged image constructed from all of these. In the original data, the cell nucleus is shown as violet, the mitochondria are red, golgi are green, the plasma membrane is blue, the endoplasmic reticulum is orange, and the peroxisomes are white, although the colours can only be reproduced in greyscale here.

FIG. 9b shows a seven-colour image of live U2OS cells captured with the spinning disc confocal microscope of FIG. 8a. The cells were labelled with TagBFP, Cerulean, mAzami Green, Citrine, mCherry, iRFP670 and LysoTracker Yellow HCK-123. A merged image is shown. In the original data, the cell nucleus is shown as violet, the mitochondria are red, golgi are green, the plasma membrane is blue, the endoplasmic reticulum is orange, the peroxisomes are cyan and the lysosomes are magenta, although the colours can only be reproduced in greyscale here.

FIG. 9c shows a seven-colour image of live U2OS cells captured with the spinning disc confocal microscope of FIG. 8a. The cells were labelled with TagBFP, Cerulean, mAzami Green, Citrine, mCherry, iRFP670 and FASTACT 555 Actin. A merged image is shown. In the original data, the cell nucleus is shown as violet, the mitochondria are red, golgi are green, the plasma membrane is grey, the endoplasmic reticulum is orange, the peroxisomes are white and actin is magenta, although the colours can only be reproduced in greyscale here.

FIG. 9d shows a seven-colour image of live U2OS cells captured with the spinning disc confocal microscope of FIG. 8a. The cells were labelled with TagBFP, Cerulean, mAzami Green, Citrine, mCherry, iRFP670 and SPY 555 Tubulin. A merged image is shown. In the original data, the cell nucleus is shown as violet, the mitochondria are red, golgi are green, the plasma membrane is purple, the endoplasmic reticulum is orange, the peroxisomes are magenta and microtubules are cyan, although the colours can only be reproduced in greyscale here.

FIG. 9e shows eight images of live U2OS cells captured with the oblique plane light sheet microscope of FIG. 8b. The cells were labelled with TagBFP, Cerulean, mAzami Green, Citrine, mCherry, iRFP670, SPY 555 Tubulin and LysoTracker Yellow HCK-123. The unmixed images are shown. In these component images, the cell nucleus is shown as violet, the mitochondria are red, golgi are green, the plasma membrane is grey, the endoplasmic reticulum is orange, the peroxisomes are white, the lysosomes are magenta and microtubules are cyan, although the colours can only be reproduced in greyscale here.

FIGS. 9a to 9e are single frames taken from timelapse movies showing the biological target dynamics through time.

FIG. 9f shows a five-colour image of a fixed and stained mouse brain spatial transcriptomics sample captured with the spinning disc confocal microscope of FIG. 8a. The sample was labelled with DAPI, OPAL 520, OPAL 570, OPAL 650, and OPAL 690. A merged image is shown in which the colours of the labelled biological structures are clearly visible, although the colours can only be reproduced in greyscale here.

These examples demonstrate the capabilities of the invention on a range of samples, fluorophore combinations and sizes, ranging from sub-cellular dynamics to 3D mouse brain sections. Simultaneous eight-colour dynamic imaging was possible.

The eight cameras of the camera module of FIG. 7 are monochromatic. The arrangement of dichroic mirrors and tube lenses directs a respective range of wavelengths to each of the cameras in the manner described above with respect to the splitter shown in FIG. 3. Thus, although each camera receives a different range of wavelengths, the cameras themselves do not record the associated colours. Instead, they merely produce a monochromatic image. After unmixing, there are therefore eight monochromatic images, each of a respective biological structure. It is conventional in microscopy to add “pseudocolour” to such images to enhance the visual representation. In the description of FIGS. 9a to 9f above, the colours referred to are the pseudocolours chosen for colourisation to enhance visualisation. They are not the actual colours of the fluorophores or biological structures. This explains why, in FIGS. 9a and 9c, the peroxisomes are coloured white, whereas in FIG. 9d they are coloured magenta. The white and magenta colours were chosen for what was deemed to look best in each situation. Similarly, it explains why the plasma membrane is grey in the FIG. 9c example, whereas it is blue in the FIG. 9a example and purple in the FIG. 9d example.

1. A computer-implemented multispectral imaging method for use in analysis of a sample comprising a plurality of types of fluorescent label, each of the plurality of types of fluorescent label having a respective emission spectrum, the method comprising:
receiving multi-channel image data, each channel in the multi-channel image data comprising image data derived from an unfiltered image of the sample and having a respective spectral content;
for each channel:
i) forming a vector of measured quantum particle counts from the image data for the channel, the vector having an entry for each pixel in the image;
ii) iteratively generating, for each pixel in the image, a vector of possible values having entries for the contribution made by each of the plurality of types of fluorescent label to the unfiltered image, and for each iteration, calculating a vector of expected quantum particle counts, having an entry for each pixel in the image, by multiplying the vector of possible values for each pixel by a mixing matrix defining the relationship between the unfiltered image and the multi-channel image data; and
iii) selecting the vectors of possible values for which a negative log-likelihood function describing the probability of a vector of measured quantum particle counts being generated given a corresponding vector of expected quantum particle counts is a minimum; and
for each of the plurality of types of fluorescent label in the sample, constructing a corresponding data structure comprising image data in which, for each pixel, the data structure includes the entry for the contribution made by the type of fluorescent label from the vector of possible values for the pixel, each data structure thereby being useable to reconstruct an image of the sample with a spectral content corresponding to the respective emission spectrum of the type of fluorescent label for which the data structure was constructed.

2. A method according to claim 1, wherein quantum particles in the measured quantum particle counts and expected quantum particle counts are photons.

3. A method according to claim 1, wherein a number of channels in the multi-channel image data is greater than 3.

4. A method according to claim 1, wherein the iterative generation of step (ii) and selection of step (iii) are carried out using an optimization algorithm, the optimization algorithm being one of limited-memory Broyden-Fletcher-Goldfarb-Shanno, conjugate gradient descent, Adam, or Richardson-Lucy.

5. A method according to claim 4, wherein the optimization algorithm is Richardson-Lucy which performs the iterative generation of step (ii) according to the following equation:
$${u}_{k + 1} = {u}_{k} [ {H}^{T} ( \frac{d}{H {u}_{k}} ) ]$$
where: uₖ is a current iteration of the vector of possible values;
uₖ₊₁ is the next iteration of the vector of possible values;
H is the mixing matrix, and H^{T} its transpose; and
d is the vector of measured quantum particle counts;
and wherein the vector of possible values selected in step (iii) is the final value of uₖ₊₁ generated prior to interruption of the iterative generation, the interruption being triggered when over a predefined number of successive iterations, the values of uₖ₊₁ differ by less than a threshold amount.

6. A method according to claim 1, wherein the mixing matrix defines, in addition to the relationship between the unfiltered image and the multi-channel image data, a function for deblurring caused by diffraction or other optical effects.

7. A method according to claim 1, further comprising generating the mixing matrix.

8. A method according to claim 1, further comprising
generating the multi-channel image data by splitting light received from an image source which produces the unfiltered image into a number of optical paths, the number of optical paths equal to a number of channels in the multi-channel image data and each optical path having the same spectral content as a corresponding one of the channels;
forming an image from the light in each optical path; and
generating image data for the channel corresponding to the optical path from the image formed

9. A method according to claim 8, wherein the light received from the image source is split into the optical paths using an array of dichroic mirrors, and the image in each optical path is formed on a respective camera which generates the image data.

10. A multispectral imaging system for use in analysis of a sample comprising a plurality of types of fluorescent label, each of the plurality of types of fluorescent label having a respective emission spectrum, the system comprising at least one processor coupled to at least one memory device, the memory device storing instructions which, when executed, cause the processor to carry out the method of claim 1.

11. A system according to claim 10, further comprising
an array of dichroic mirrors to split light received from an image source which produces the unfiltered image into a number of optical paths, the number of optical paths equal to a number of channels in the multi-channel image data and each optical path having the same spectral content as a corresponding one of the channels; and
a camera in each optical path on which an image is formed to generate the image data for the channel corresponding to the optical path.

12. A computer readable medium storing instructions to be executed by a processor forming part of a multispectral imaging system for use in analysis of a sample comprising a plurality of types of fluorescent label, each of the plurality of types of fluorescent label having a respective emission spectrum, wherein the instruction, when executed on the processor, cause the processor to carry out the method of claim 1.
